(19) United States
(12) Patent Application Publication
(10) Pub. No.: US 2005/0074535 A1
(43) Pub. Date: Apr. 7, 2005

(54) Soy milk juice beverage

(76) Inventors: Joel I. Dulebohn, Lansing, MI (US); Ronald J. Carlotti, Grand Rapids, MI (US)

Correspondence Address: FOLEY & LARDNER, 777 EAST WISCONSIN AVENUE, SUITE 3800, MILWAUKEE, WI, 53202-5308, US

(21) Appl. No.: 10/433,809

(22) PCT Filed: Dec. 17, 2001
(86) PCT No.: PCT/US01/49055

Related U.S. Application Data
(60) Provisional application No. 60/256,996, filed on Dec. 20, 2000.

(51) Int. Cl. A23L 2/38

(52) U.S. Cl. 426/598

(57) ABSTRACT

A self-stable beverage including soy milk, fruit juice and/or vegetable juice, a gum-basse stabilizer, and a composition comprising an amino acid, an organic acid or inorganic acid and a metal ion is disclosed. The pH of the stable beverage is typically between 3.0 to 4.6. The beverage is stable for at least two weeks and preferably up to over 3 months at room temperature (72° F. or 22° C.) and/or refrigerator temperature (40° F. or 4° C.). The beverage is easier to process and provides superior uniformity of flavors, clean taste, appearance, and excellent nutritional attributes. In addition, the beverage exhibits negligible separation, sediments or precipitate.

### CROSS-REFERENCES TO RELATED APPLICATIONS

This application claims the benefit of U.S. Provisional Patent Application No. 60/256,996 filed Dec. 20, 2000.

### STATEMENT REGARDING FEDERALLY SPONSORED RESEARCH

Not Applicable.

### BACKGROUND OF THE INVENTION

1. Field of the Invention

This invention relates to beverages including soy milk and a juice such as a fruit juice, a vegetable juice or a mixture of fruit and vegetable juices. More particularly, this invention relates to a stable soy milk/juice beverage with negligible separation, sediments, or precipitate.

2. Description of the Related Art

Soy milk is a water extract of soybeans which has been found to be nutritionally comparable to cow's milk in most respects. Since soy milk does not contain lactose and has no cholesterol, it is an ideal substitute for cow's milk for lactose-intolerant individuals and those on restricted cholesterol intake diets. Furthermore, soy milk is an important source of phytoestrogens which provide health and wellness.

Although methods of extracting soy milk from the soybean are well known, widespread acceptance of soy milk in Western countries as a substitute for cow's milk has not been forthcoming. Typically, subjective factors have limited the acceptance of soy milk. For instance, soy milk has a distinct odor and taste which differs from cow's milk, and as a result, many Westerners have deemed soy milk to be less desirable than cows milk.

Given the nutritional benefits of soy milk, it is not surprising that the food industry has investigated various food additives that can modify the taste of soy milk such that the modified soy milk is more palatable to Westerners. For example, there is interest in the food industry to combine soy milk and juice to form a good-tasting beverage. However, the combination of soy milk and juice in a beverage has presented two main problems. First, the resulting beverage must be formulated to have good taste. Second, interaction between acidic juices and acid sensitive ingredients, such as the soy proteins in soy milk, can occur. For instance, precipitation or curdling of soy milk or soy proteins via a protein-acid interaction is common. Also, in the presence of an acid, temperature treatments such as pasteurization can increase the precipitation or curdling of soy milk or soy proteins. Thus, stability and good taste are the two biggest barriers to overcome in formulating a soy milk/juice beverage.

In view of the nutritional benefits of soy milk and the desire for more palatable soy milk, there is a need for a method for improving the taste of soy milk with juice wherein the stability problems associated with the precipitation or curdling of soy milk or soy proteins are eliminated or minimized over a wide temperature range.

### BRIEF SUMMARY OF THE INVENTION

The foregoing need is met by the present invention which is a unique combination of gum-based stabilizer and a composition comprising an amino acid, an organic acid or inorganic acid and a metal ion wherein the combination serves to stabilize a soy milk/juice mixture at room temperature and at refrigerated temperature. The composition comprising an amino acid, an organic acid or inorganic acid, and a metal ion seems to be acting as a process aid in stabilizing these drinks at high temperature. The composition comprising an amino acid, an organic acid or inorganic acid, and a metal ion is also interacting with the gum and soy milk proteins in a way that enhances the stability of the soy milk/juice beverage.

In one embodiment, the present invention is a soy milk drink comprising soy milk, juice, gum-based stabilizer, and a composition comprising an amino acid, an organic acid or inorganic acid, and a metal ion. The soy milk drink is typically at a pH range of 3.0 to 7.0, preferably at a pH range of 3.0 to 4.6, with little or no separation, sediments, or precipitate. These beverages can vary from a thick drink to a fluid drink and are smooth and refreshing. The beverage is nutritious and can be further enhanced with sweeteners, acidulents, vitamins, minerals, isoflavones, additional soy protein, and other nutrients.

Therefore, it is an advantage of the present invention to provide a soy milk and juice beverage wherein the stability problems associated with the precipitation or curdling of soy milk or soy proteins are eliminated or minimized over a wide temperature range. It is another advantage of the present invention to provide a soy milk and juice beverage with negligible separation, sediments, or precipitate. It is still another advantage of the present invention to provide a soy milk and juice beverage having good taste characteristics. Other advantages and features of the present invention will become apparent to one skilled in the art after reading the specification and claims.

### DETAILED DESCRIPTION

The present invention provides a shelf-stable beverage comprising soy milk, fruit juice and/or vegetable juice, a gum-based stabilizer, and a composition comprising an amino acid, an organic acid or inorganic acid and a metal ion. Optionally, the beverage may include an acidulent, a sweetener, food additives (e.g., nutrients), alcohol, carbonation, and flavors. The pH of these stable beverages is typically between 3.0 to 4.6. These drinks are stable for at least and up to two weeks to over one year at room temperature (72° F. or 22° C.) and/or refrigerator temperature (40° F. or 4° C.). These resulting beverages are easier to process and provide superior uniformity of flavors, clean taste, and appearance.

In one embodiment of present invention, a combination of a gum-based stabilizer and a composition comprising an amino acid, an organic acid or inorganic acid, and a metal ion is used to stabilize a soy milk/juice combination at both room temperature and refrigerated temperature. The gum-based stabilizer may be selected from the group consisting of pectin, alginate, carboxymethyl cellulose, locust bean gum, xanthan gum, gellan gum, guar gum, carrageenan, gum ghatti, karaya gum, tragacanth, gum arabic, gelatin and mixtures thereof. Typically, these beverages are stable for up to one year. A preferred beverage of the present invention is stable at room temperature for at least two weeks, preferably for up to three months, and most preferably for six months. In another embodiment of the present invention, the beverage is stable at refrigerated temperature for up to two weeks, preferably up to 3 months, and most preferably for 6 months.

The soy milk portion can vary from 5 weight % to 80 weight % based on the total weight of the mixture, and the juice portion can vary from 5 weight % to 80 weight % based on the total weight of the mixture. Preferably, the soy milk is included in the mixture at between 35 weight % and 45 weight/based on the total weight of the mixture, and the juice is included in the mixture at between 35 weight % and 45 weight % based on the total weight of the mixture. The juice may be either pulp or pulp free juice. As this ratio of soy milk/juice varies, the amount of gum-based stabilizer and the composition comprising an amino acid, and organic acid or inorganic acid and a metal ion also have to vary to prepare these stable drinks. The gum-based stabilizer portion may vary from 0.01 weight % to 3 weight % based on the total weight of the mixture, and the composition comprising an amino acid, and organic acid or inorganic acid and a metal ion may vary from 0.001 weight % to 3 weight % based on the total weight of the mixture for a solution that is 65% solids (e.g., 35 grams of water and 65 grams of the composition comprising an amino acid, an organic acid or inorganic acid, and a metal ion). The amount of optional sweetener may also be varied depending on the ratio of soy milk/juice and the choice of juice, and preferably, the sweetener portion varies from 0 to 25 weight % based on the total weight of the mixture.

In the present invention, a soy milk emulsion is created from a combination of soy milk and a juice. By “juice” we mean to include any products containing fruit or vegetable juice, such as drinks, jams, jellies and other fruit and vegetable products. In one example embodiment of the present invention, a soy milk emulsion is created from a combination of soy milk and a fruit juice. Non-limiting examples of fruit juices include apple juice, orange juice, pineapple juice, cherry juice, grape juice, grapefruit juice, lemon juice, melon juice, strawberry juice, black cherry juice, lemon-lime juice, mango juice, papaya juice, cranapple juice, fruit punch juice, peach juice, guava juice, tangerine juice, apricot juice, and cranberry juice, or juice drinks, such as lemonade, orangeade and fruit punch, and mixtures thereof. A typical fruit juice, such as orange juice, has a density of 1.05 g./cm.³. Fruit products, such as jams and jellies, are also preferred, along with juices prepared from jams and jellies.

In another example embodiment of the present invention, the emulsion is created from a combination of soy milk and a vegetable juice. Non-limiting examples of vegetable juices include carrot, celery, cabbage, tomato, vegetable juice, mixed vegetable juice, and mixtures thereof. In still another example embodiment of the present invention, the emulsion is created from a combination of soy milk and mixtures of any the vegetable and fruit juices listed above.

We believe that the composition comprising an amino acid, an organic acid or inorganic acid, and a metal ion stabilizes the soy milk proteins by binding the proteins and preventing denaturation and precipitation in the more acidic environment of the fruit and/or vegetable juice. A composition comprising an amino acid, an organic acid or inorganic acid, and a metal ion has carboxylic acid, hydroxyl, and amine functional groups and metal ions to bind the soy milk proteins. One example of such a composition can be found in U.S. Pat. No. 5,766,636, which is incorporated herein by reference and describes the preparation of such a composition.

The specific gravity of the composition comprising of an amino acid, an organic acid/inorganic acid and a metal ion source can vary from 1.0 to 1.5 grams per milliliter; and the typical value varies from 1.2 to 1.3 grams per milliliter. The specific gravity of soy milk and juice can be brought closer together using the composition comprising an amino acid, and organic acid/inorganic acid and a metal ion source. It is important to maintain the soy milk/juice emulsion in a pH range of, preferably, pH 3.0 to pH 4.6.

The composition comprising an amino acid, an organic acid or inorganic acid, and a metal ion is a mixture of an amino acid, a metal ion source (such as Group IA, IIA, Ti, V, Cr, Mn, Fe, Co, Ni, Cu, Zn and Se), organic acids and inorganic acids. Typically, the organic acids are mono, di, tri, and poly carboxylic acids, and may contain other functional groups such as NH₂⁻, OH⁻, PO₄⁻³ and SO₄⁻². Typically, the inorganic acids are hydrochloric acid, sulfuric acid and phosphoric acid. The molar ratio of metal ion:amino acid:acid can vary depending on the application. The molar ratio of amino acid to metal ion can vary from 0.1 to 20. The acids to metal ion molar ratio can vary from 0.1 to 20. The most common molar ratio for food applications is amino acid varying from 0.1 to 4, and the acid varying from 0.1 to 4. These molar ratios keep the composition comprising an amino acid, and organic acid or inorganic acid and a metal ion in the pH range of 3-8 for most of the food applications.

An example of a composition comprising an amino acid, an organic acid or inorganic acid, and a metal ion includes: 1571.5 grams water; 1155.1 grams lysine HOH (7.03 mole); 189.1 grams MgO (4.69 mole); 1365.1 grams malic acid (10.18 mole); and 654.5 grams citric acid (3.41 mole). The pH of the solution varies from 3.5 to 3.8 and is approximately 65% solids. The molar ratio of lysine HOH:metal oxide:organic acids is preferably 1.5:1.0:2.9. This is the preferred formula of the composition comprising an amino acid, an organic acid or inorganic acid, and a metal ion, and is used in the Examples below. However, other versions of the composition can be used. Instead of lysine, other amino acids, peptides and proteins can be used, and one may substitute different metal ions, for example, calcium, zinc, iron and others. The organic acids can be varied and the ratio of the organic acid can be varied. The pH of the composition comprising an amino acid, an organic acid or inorganic acid, and a metal ion can be varied from 3.0 to 8.0.

Various optional ingredients may be added to the soy milk/juice mixture. For example, a sweetener selected from high fructose corn syrup, corn syrup, glucose, fructose, honey, lactose, sugar and mixtures thereof may be added to the soy milk/juice mixture. Also, a high intensity sweetener selected from acesulfame K, sucralose, aspartame, alitame and mixtures thereof may be added to the soy milk/juice mixture. An acidulent may also be added to the soy milk/juice mixture. Non-limiting examples of acidulents include: organic acids selected from citric acid, malic acid, succinic acid, lactic acid, tartaric acid, gluconic acid, ascorbic acid, other food grade organic acids, and mixtures thereof; and inorganic acids selected from hydrochloric acid, sulfuric acid, phosphoric acid, nitric acid, and mixtures thereof. Conventional food additives may also be added to the soy milk/juice mixture, such as caffeine, vitamins (pyridoxine, riboflavin, vitamin D, niacin, phylloquinone), minerals (Ca, Mg, Fe, Co, Zn, Mn, Cr (III), Cu, Mo, P, Se), folic acid, ginkgo, garlic, isoflavones, soy proteins, L-carnitine, licorice, beta-carotene, peppermint, polyphenol, herbal extracts, botanicals, and mixtures thereof. In particular, the use of additional soy protein isolate (i.e., soy protein that has been separately isolated from soy milk) is quite beneficial as the level of protein in the soy milk/juice mixture can be increased above the level of proteins provided by the soy proteins typically present in soy milk. Carbonation and/or alcohol may also be added to the soy milk/juice composition.

Typically, one first blends a composition comprising an amino acid, organic acid or inorganic acid, and a metal ion with the soy milk and then adds at least one gum-based stabilizer. The mixture may be stirred, blended, homogenized or otherwise mixed. Sweeteners, if desired, may then be added to the mixture. The mixture then stands for 15 minutes. The juice and other optional ingredients are then added and the pH of the mixture may be lowered to 4.6 or below with an acidulent, such as one or more of the above-described acidulents. The beverage is then allowed to stand for 5 minutes and then microwaved to 86° C. (186° F.). Other heating methods can be used such as conventional heating, induction, solar convection, or direct electrical resistance methods for sterilization, ultra high temperature processing, and pasteurization. The beverage may be carbonated, if desired. The beverage can be packed in a clean sterile package, either hot or cooled. If the method of the present invention is not used, undesirable results begin usually at around a pH of 5.0 when the soy milk protein starts to coagulate and two layers begin to form (the bottom layer will be soy milk proteins, and the top layer will be a liquid).

The soy milk can be prepared by any suitable conventional method. Likewise, already available, commercial soy milk can be used herein. Typically, soy milk has a density of 1.02 g./cm.³. The soy milk used below in the Examples was calcium enriched, low 1% fat and vitamin enriched. We envision that other soy milks would be equally successful. The soy milk ingredients were filtered water, organic whole soybeans (i.e., organically grown and processed in accordance with the California Organic Foods Act of 1990), naturally milled organic cane (i.e., organically grown and processed in accordance with the California Organic Foods Act of 1990), calcium carbonate, sea salt, natural flavors, carrageenan, vitamin A palmitate, vitamin D2, Riboflavin (B2), and Vitamin B12. The following nutrition facts appeared on the label:

Serving Size 1 cup (240 milliliters)
Calories 80
Calories from fat 20
% Daily Value

| | |
|---|---|
| Total fat 2.5 g | 4% |
| Saturated fat 0 g | 0% |
| Cholesterol 0 mg | 0% |
| Sodium 75 mg | 3% |
| Total Carbohydrate 8 g | 3% |
| Dietary Fiber 0 g | 0% |
| Sugars 4 g | |
| Protein 7 g | |
| Vitamin A | 10% |
| Vitamin C | 0% |
| Calcium | 30% |
| Vitamin D | 30% |
| Riboflavin | 30% |
| Vitamin B12 | 50% |

### EXAMPLES

The following examples are intended only to further illustrate the invention and are not intended to limit the scope of the invention which is defined by the claims.

### Example 1

### Soy Milk and Frozen Pulp Orange Juice

To 450 milliliters of soy milk, we added 2.0 grams of a composition comprising an amino acid, an organic acid or inorganic acid, and a metal ion (65% solids) and stirred using a blender at the whip setting for a few seconds. With stirring, we added 8.0 grams of pectin. When all the pectin was added, we then added 125 grams of high fructose corn syrup and whipped for one minute. We let the gum hydrate for fifteen minutes. With stirring (blender on whip setting), we then added 1.46 grams of mango flavor and 1.46 gram of orange flavor, then added 450 milliliters of orange juice, 63 milliliters of water and 8 milliliters of 1:1 30% citric acid:malic acid solution (15 grams of citric acid plus 15 grams of malic acid and 70 milliliters of water). We set the blender to liquefy setting and liquefied the beverage for one minute. We poured the beverage into a beaker and let sit for 5 minutes. We microwaved the beverage on a high setting until the temperature was between 186° F. to 194° F. for 30 seconds and then cooled the beverage in an ice-water bath. We then placed the beverage in clean container.

The beverage was stored at room temperature (72° F. or 22° C.) or refrigerator temperature (40° F. or 4° C.). The total soy protein was 2.95 grams/240 milliliters and the total protein was 3.42 grams/240 milliliters (240 milliliters is one cup serving). The room temperature sample remained stable for 2 weeks. The refrigerated sample was stable for at least 70 days.

### Example 2

### Soy Milk and Cherry Juice

To 450 milliliters of soy milk, we added 2.0 gram of a composition comprising an amino acid, an organic acid or inorganic acid, and a metal ion (65% solids) and stirred using a blender at the whip setting for a few seconds. With stirring, we added 8.0 grams of pectin. When all the pectin was added, we then added 140 grams of high fructose corn syrup and whipped for one minute. The gum hydrated for fifteen minutes. With stirring (blender on whip setting), we added 0.5 milliliters of cherry flavor and 450 milliliters cherry juice (61 milliliters of cherry concentrate and 391 milliliters of water) and then added 12 milliliters of 1:1 30% citric acid:malic acid solution. We set the blender to liquefy setting and liquefied the beverage for one minute. We poured the beverage into a beaker and let it sit for 5 minutes. We microwaved the beverage on a high setting until the temperature was between 186° F. to 194° F. for 30 seconds, cooled the beverage in an ice-water bath, and placed the beverage in clean container.

The beverage was stored at room temperature (72° F. or 22° C.) or refrigerator temperature (40° F. or 4° C.). The total soy protein was 2.91 grams/240 milliliters, and the total protein is 3.59 grams/240 milliliters (240 milliliters is one cup serving). The room temperature sample was stable for 4 weeks. The refrigerated sample was stable for at least 70 days.

### Example 3

### Soy Milk and Apple and Strawberry Juice

To 450 milliliters of soy milk, we added 2.0 grams of a composition comprising an amino acid, an organic acid or inorganic acid, and a metal ion (65% solids) and stirred using a blender at the whip setting for a few seconds. With stirring, we added 8.0 grams of pectin. When all the pectin was added, we then added 140 grams of high fructose corn syrup and whipped for one minute. We let the gum hydrate for fifteen minutes. With stirring (blender on whip setting), we added 10 milliliters of strawberry flavor, 10 gram of strawberry concentrate, 30 milliliters of water and 450 milliliters of apple juice and then added 8 milliliters of 1:1 30% citric acid:malic acid solution and 1.1 grams of natural food coloring. We set the blender to liquefy setting and liquefied the beverage for one minute. We poured the beverage into a beaker and let it sit for 5 minutes. We microwaved the beverage on a high setting until the temperature was between 186° F. to 194° F. for 30 seconds and then cooled the beverage in an ice-water bath and placed the beverage in clean container.

The beverage was stored at room temperature (72° F. or 22° C.) or refrigerator temperature (40° F. or 4° C.). The total soy protein was 2.98 grams/240 milliliters, and the total protein was 3.13 grams/240 milliliters (240 milliliters is one cup serving). The room temperature sample was stable for 6 days. The refrigerated sample was stable for at least 70 days.

### Example 4

### Soy Milk and Frozen Pulp Orange Juice

To 450 milliliters of soy milk, we added 288 milliliters of water and 4.0 grams of composition comprising an amino acid, an organic acid or inorganic acid and a metal ion (65% solids) and stirred using a blender at the whip setting for a few seconds. With stirring, we added 10.0 grams of pectin. When all the pectin was added, we added 125 grams of high fructose corn syrup and 13.3 grams of soy protein and then whipped for two minutes. The gum hydrated for fifteen minutes. With stirring, we separately added 1.46 grams of mango flavor and 1.46 gram of orange flavor, 225 milliliters orange juice made from frozen pulp orange juice (112.5 milliliters of concentrated orange juice plus 112.5 milliliters of water), and then added 14 milliliters of 1:1 30% citric acid:malic acid solution. We set the blender to liquefy setting and liquefied the beverage for two minutes. We poured the beverage into a beaker and let it sit for 5 minutes. We microwaved the beverage on a high setting until the temperature was between 186° F. to 194° F. for 30 seconds, cooled the beverage in an ice-water bath, and placed the beverage in clean container.

The beverage was stored at room temperature (72° F. or 22° C.) or refrigerator temperature (40° F. or 4° C.). The total soy protein was 5.76 grams/240 milliliters, and the total protein was 6.44 grams/240 milliliters (240 milliliters is one cup serving). Both room temperature and refrigerated samples were stable for 26 days.

Thus, there has been provided a stable soy milk/juice beverage with negligible separation, sediments, or precipitate. Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

### INDUSTRIAL APPLICABILITY

The invention provides beverages including soy milk and fruit and/or vegetable juice. More particularly, this invention relates to a stable soy milk/juice beverage with negligible separation, sediments, or precipitate.

1. An edible mixture comprising:
soy milk;
a juice;
a gum-based stabilizer; and
a composition comprising an amino acid, an organic acid or inorganic acid, and a metal ion,
wherein the pH of the mixture is between 3.0 and 7.0.

2. The mixture of claim 1 wherein:
the mixture does not separate into separate phases or precipitate when stored at room temperature (72° F. or 22° C.) for 2 weeks.

3. The mixture of claim 1 wherein:
the mixture does not separate into separate phases or precipitate when stored at refrigerator temperature (40° F. or 4° C.) for 2 weeks.

4. (canceled)

5. The mixture of claim 1 wherein:
the pH of the mixture is between 3.0 and 4.6.

6-9. (canceled)

10. The mixture of claim 1 wherein:
the juice is obtained from fruit selected from apple, orange, pineapple, cherry, grape, grapefruit, lemons, melons, strawberries, black cherry, lemon-lime, mango, papaya, cranapple, fruit punch, peach, guava, tangerine, apricot, cranberry, and mixtures thereof.

11. The mixture of claim 1 wherein:
the juice is a vegetable juice.

12. The mixture of claim 11 wherein:
the juice is selected from carrot juice, celery juice, cabbage juice, tomato juice, mixed vegetable juice, and mixtures thereof.

13. The mixture of claim 1 wherein:
the mixture comprises 0.01 weight % to 3 weight % of the gum-based stabilizer based on the total weight of the mixture.

14. The mixture of claim 1 wherein:
the gum-based stabilizer is selected from the group consisting of pectin, alginate, carboxymethyl cellulose, locust bean gum, xanthan gum, gellan gum, guar gum, carrageenan, gum ghatti, karaya gum, tragacanth, gum arabic, gelatin and mixtures thereof.

15. The mixture of claim 1 wherein:
the mixture comprises 0.001 weight % to 3 weight % of the composition comprising an amino acid, an organic acid or inorganic acid, and a metal ion based on the total weight of the mixture.

16. The mixture of claim 1 wherein:
the composition comprising an amino acid, an organic acid or inorganic acid, and a metal ion is a solution comprising water, lysine HOH, magnesium oxide, malic acid, and citric acid, and the pH of the solution varies from 3.5 to 3.8.

17-18. (canceled)

19. The mixture of claim 1 further comprising:
a sweetener selected from high fructose corn syrup, corn syrup, glucose, fructose, honey, lactose, sugar, and mixtures thereof.

20. The mixture of claim 1 further comprising:
a high intensity sweetener selected from acesulfame K, sucralose, aspartame, alitame, and mixtures thereof.

21. The mixture of claim 1 further comprising:
an acidulent selected from citric acid, malic acid, succinic acid, lactic acid, tartaric acid, gluconic acid, ascorbic acid, other food grade organic acids, and mixtures thereof.

22. The mixture of claim 1 further comprising:
an acidulent selected from hydrochloric acid, sulfuric acid, phosphoric acid, nitric acid, and mixtures thereof.

23. The mixture of claim 1 further comprising:
a food additive selected from caffeine, vitamins (pyridoxine, riboflavin, vitamin D, niacin, phylloquinone), minerals (Ca, Mg, Fe, Co, Zn, Mn, Cr (III), Cu, Mo, P, Se) folic acid, ginkgo, garlic, isoflavones, soy proteins, L-camitine, licorice, beta-carotene, peppermint, polyphenol, herbal extracts, botanicals, and mixtures thereof.

24. The mixture of claim 1 further comprising:
soy protein isolate.

25. The mixture of claim 1 further comprising:
alcohol.

26. An edible mixture comprising:
5 weight % to 80 weight % of soy milk;
5 weight % of 80 weight % of a juice;
0.01 weight % to 3 weight % of a gum-based stabilizer; and
0.001 weight % to 3 weight % of a composition comprising an amino acid, an organic acid or inorganic acid, and a metal ion,
wherein the pH of the mixture is between 3.0 and 7.0, and all weight percentages are based on the total weight of the mixture.

27-33. (canceled)

34. A method for preparing a soy milk product, the method comprising:
adding a juice, a gum-based stabilizer and a composition comprising an amino acid, an organic acid or inorganic acid, and a metal ion to soy milk to form a soy milk product.

35-49. (canceled)
